(19) United States
(12) Patent Application Publication
(10) Pub. No.: US 2026/0158671 A1
(43) Pub. Date: Jun. 11, 2026

(54) SUBSTRATE TRANSFER ROBOT, METHOD OF RECOGNIZING POSITION OF SUBSTRATE, AND SUBSTRATE PROCESSING APPARATUS

(71) Applicant: SEMES CO., LTD., Cheonan-si (KR)

(72) Inventors: Ki Won HAN, Cheonan-si (KR); Sang Mo YANG, Cheonan-si (KR)

(73) Assignee: SEMES CO., LTD., Cheonan-si (KR)

(21) Appl. No.: 19/180,253

(22) Filed: Apr. 16, 2025

(30) Foreign Application Priority Data
Jul. 15, 2024 (KR) 10-2024-0093308

(51) Int. Cl. B25J 11/00; B25J 9/16; B25J 13/08; B25J 19/02

(52) U.S. Cl. CPC B25J 11/0095; B25J 9/1697; B25J 13/089; B25J 19/023

(57) ABSTRACT

Disclosed are a substrate transfer robot capable of accurately recognizing the positions of a plurality of substrates while transferring the substrates, a method of recognizing the positions of the substrates by the substrate transfer robot, and a substrate processing apparatus including the substrate transfer robot. The substrate transfer robot includes a robot arm, an upper robot hand coupled to the robot arm to support a first substrate from below, a lower robot hand coupled to the robot arm at a position below the upper robot hand to support a second substrate from below, an upper camera disposed above the upper robot hand, and a lower camera disposed below the lower robot hand. The upper camera and the lower camera capture images of the first substrate and the second substrate in directions tilted from inner sides of the first and second substrates toward outer sides of the first and second substrates.

### CROSS-REFERENCE TO THE RELATED APPLICATION

The present application claims priority to and the benefit of Korean Patent Application No. 10-2024-0093308, filed on Jul. 15, 2024, in the Korean Intellectual Property Office, the entire disclosure of which is incorporated herein by reference.

### BACKGROUND

### 1. Field

The present disclosure relates to a substrate transfer robot configured to transfer a substrate, a method of recognizing the position of the substrate by the substrate transfer robot, and a substrate processing apparatus including the substrate transfer robot.

### 2. Description of the Related Art

A semiconductor (or display) manufacturing process is a process for manufacturing a semiconductor device on a substrate (e.g., a wafer), and includes, for example, exposure, deposition, etching, ion implantation, and cleaning. In order to perform each manufacturing process, semiconductor manufacturing equipment that performs each process is provided in a clean room of a semiconductor manufacturing plant, and each process is performed on a substrate loaded in the semiconductor manufacturing equipment.

A substrate transfer robot is provided to transfer a substrate between modules in semiconductor manufacturing equipment. The substrate transfer robot may transfer a plurality of substrates simultaneously. The substrate transfer robot may include a plurality of robot hands disposed in a vertical direction. A plurality of substrates may be transferred while being disposed on respective robot hands in the vertical direction.

In order to accurately place a substrate at a target position, the substrate transfer robot needs to accurately recognize the position of the substrate. A conventional method of detecting the position of a substrate is shown in FIG. 3 of Korean Patent Registration No. 2443868, in which position misalignment of a substrate is detected using light radiated from a light-emitting unit 131 to a light-receiving unit 132.

As in the conventional method, if light is radiated in the vertical direction in a state in which a plurality of substrates is stacked, it is possible to detect the presence of a misaligned substrate among the plurality of substrates. However, it is not possible to determine which substrate is misaligned or the degree of misalignment.

### SUMMARY

The present disclosure provides a substrate transfer robot capable of accurately recognizing the positions of a plurality of substrates while transferring the substrates, a method of recognizing the positions of the substrates by the substrate transfer robot, and a substrate processing apparatus including the substrate transfer robot.

A substrate transfer robot configured to transfer a substrate in a substrate processing apparatus according to the present disclosure includes a robot arm, an upper robot hand coupled to the robot arm to support a first substrate from below, a lower robot hand coupled to the robot arm at a position below the upper robot hand to support a second substrate from below, an upper camera disposed above the upper robot hand, and a lower camera disposed below the lower robot hand. The upper camera and the lower camera capture images of the first substrate and the second substrate in directions tilted from inner sides of the first and second substrates toward outer sides of the first and second substrates.

In the embodiment of the present disclosure, the substrate transfer robot may further include a lighting device disposed below the lower robot hand to radiate light.

In the embodiment of the present disclosure, the upper camera may capture a first image of the edge of the first substrate from above the upper robot hand.

In the embodiment of the present disclosure, the position of the first substrate on the upper robot hand may be recognized using the first image.

In the embodiment of the present disclosure, when it is determined based on the first image captured by the upper camera that the position of the first substrate is offset from a designated position, the upper robot hand or the robot arm may be moved by a distance corrected based on offset of the first substrate.

In the embodiment of the present disclosure, the lower camera may capture a second image of the edge of the second substrate from below the lower robot hand.

In the embodiment of the present disclosure, the position of the second substrate on the lower robot hand may be recognized using the second image.

In the embodiment of the present disclosure, when it is determined based on the second image captured by the lower camera that the position of the second substrate is offset from a designated position, the lower robot hand or the robot arm may be moved by a distance corrected based on offset of the second substrate.

A method of recognizing a position of a substrate by the above-described substrate transfer robot configured to transfer the substrate in a substrate processing apparatus according to the present disclosure includes capturing, by the upper camera and the lower camera, images of the first substrate and the second substrate and recognizing positions of the first substrate and the second substrate using the captured images.

A substrate processing apparatus according to the present disclosure includes a load port including a mounting table configured to allow a cassette receiving a substrate to be placed thereon, a linkage module providing a space to store the substrate, and an index module including an index robot configured to transfer the substrate between the load port and the linkage module. The index robot includes a robot arm, an upper robot hand coupled to the robot arm to support a first substrate from below, a lower robot hand coupled to the robot arm at a position below the upper robot hand to support a second substrate from below, an upper camera disposed above the upper robot hand, and a lower camera disposed below the lower robot hand. The upper camera and the lower camera capture images of the first substrate and the second substrate in directions tilted from inner sides of the first and second substrates toward outer sides of the first and second substrates. The upper camera captures a first image of the edge of the first substrate from above the upper robot hand, and the lower camera captures a second image of the edge of the second substrate from below the lower robot hand. The position of the first substrate on the upper robot hand and the position of the second substrate on the lower robot hand are recognized using the first image and the second image.

### BRIEF DESCRIPTION OF THE DRAWINGS

The accompanying drawings, which are incorporated in this specification, illustrate exemplary embodiments and serve to further illustrate the technical ideas of the disclosure in conjunction with the detailed description of exemplary embodiments that follows, and the disclosure is not to be construed as limited to what is shown in such drawings. In the drawings:

FIG. 1 is a view of a substrate processing apparatus when viewed from above;

FIG. 2 is a view of the substrate processing apparatus when viewed from direction A-A in FIG. 1;

FIG. 3 is a view of the substrate processing apparatus when viewed from direction B-B in FIG. 1;

FIG. 4 is a view of the substrate processing apparatus when viewed from direction C-C in FIG. 1;

FIG. 5 is a view of an index robot as an example of a substrate transfer robot;

FIG. 6 is a view showing a state in which the index robot unloads substrates from a cassette;

FIG. 7 is a side view showing a state in which an upper robot hand and a lower robot hand support the substrates;

FIG. 8 is a plan view showing a state in which the upper robot hand and the lower robot hand support the substrates;

FIG. 9 is a view schematically showing a structure for recognizing the positions of the substrates;

FIGS. 10A and 10B illustrate a process of recognizing the position of a first substrate using an upper camera;

FIGS. 11A and 11B illustrate a process of recognizing the position of a second substrate using a lower camera; and

FIG. 12 is a flowchart showing a method of recognizing the positions of the substrates by the substrate transfer robot.

### DETAILED DESCRIPTION OF EXEMPLARY EMBODIMENTS

Hereinafter, embodiments of the present disclosure will be described in detail with reference to the accompanying drawings so that those skilled in the art can easily carry out the embodiments. The present disclosure may, however, be embodied in many different forms, and should not be construed as being limited to the embodiments set forth herein.

Parts irrelevant to description of the present disclosure will be omitted to clearly describe the present disclosure, and the same or similar constituent elements will be denoted by the same reference numerals throughout the specification.

In addition, constituent elements having the same configurations in several embodiments will be assigned with the same reference numerals and described only in the representative embodiment, and only constituent elements different from those of the representative embodiment will be described in the other embodiments.

Throughout the specification, when a constituent element is said to be “connected”, “coupled”, or “joined” to another constituent element, the constituent element and the other constituent element may be “directly connected”, “directly coupled”, or “directly joined” to each other, or may be “indirectly connected”, “indirectly coupled”, or “indirectly joined” to each other with one or more intervening elements interposed therebetween. In addition, throughout the specification, when a constituent element is referred to as “comprising”, “including”, or “having” another constituent element, the constituent element should not be understood as excluding other elements, so long as there is no special conflicting description, and the constituent element may include at least one other element.

Unless otherwise defined, all terms used herein, which include technical or scientific terms, have the same meanings as those generally appreciated by those skilled in the art. The terms, such as ones defined in common dictionaries, should be interpreted as having the same meanings as terms in the context of pertinent technology, and should not be interpreted as having ideal or excessively formal meanings unless clearly defined in the specification.

A substrate processing apparatus as semiconductor manufacturing equipment of an embodiment may be used to perform a process on a substrate such as a semiconductor wafer or a flat display panel. In particular, the substrate processing apparatus of the embodiment may be connected to an exposure apparatus and may be used to perform an application process and a development process on a substrate.

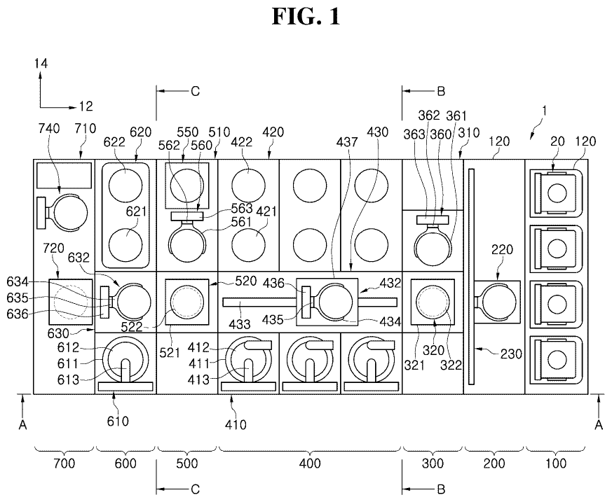

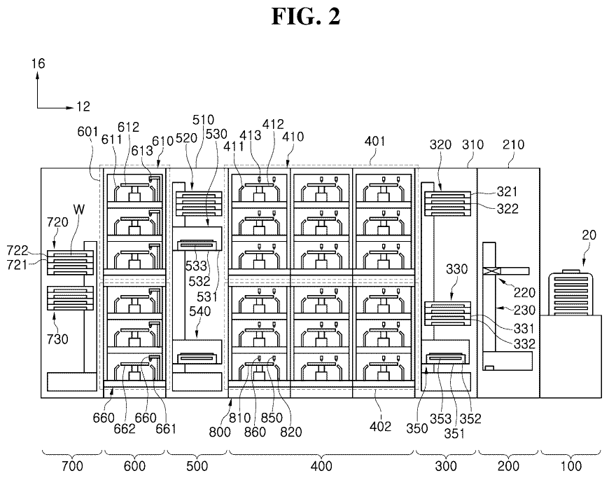

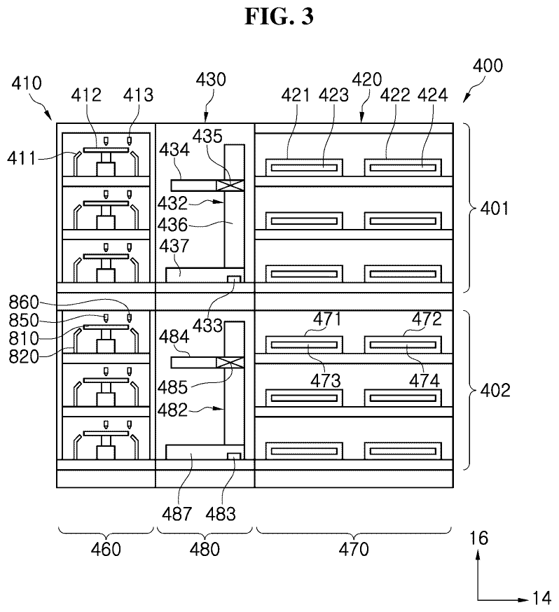

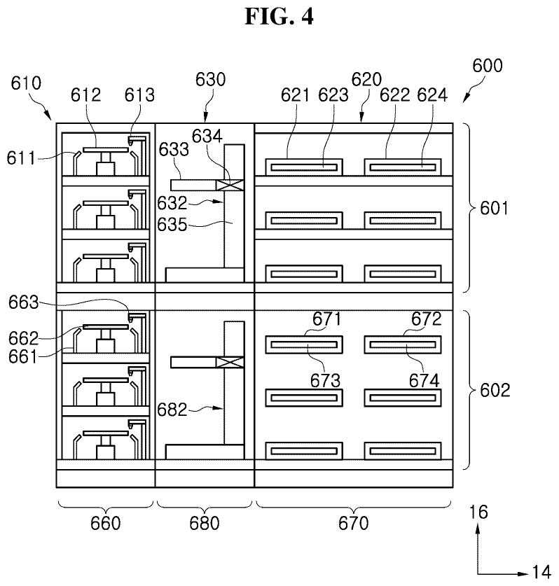

FIG. 1 is a view of a substrate processing apparatus when viewed from above, FIG. 2 is a view of the substrate processing apparatus when viewed from direction A-A in FIG. 1, FIG. 3 is a view of the substrate processing apparatus when viewed from direction B-B in FIG. 1, and FIG. 4 is a view of the substrate processing apparatus when viewed from direction C-C in FIG. 1.

Referring to FIGS. 1 to 4, the substrate processing apparatus 1 includes a load port 100, an index module 200, a linkage module 300, an application/development module 400, a buffer module 500, a pre/post-exposure treatment module 600, and an interface module 700. The load port 100, the index module 200, the linkage module 300, the application/development module 400, the buffer module 500, the pre/post-exposure treatment module 600, and the interface module 700 are sequentially disposed in a row in one direction.

Hereinafter, a direction in which the load port 100, the index module 200, the linkage module 300, the application/development module 400, the buffer module 500, the pre/post-exposure treatment module 600, and the interface module 700 are disposed will be referred to as a first direction 12, a direction that is perpendicular to the first direction 12 when viewed from above will be referred to as a second direction 14, and a direction that is perpendicular to the first direction 12 and the second direction 14 will be referred to as a third direction 16.

A substrate W is transferred while being received in a cassette 20. In this case, the cassette 20 has a structure that is sealed from the outside. For example, a front opening unified pod (FOUP) that has a door on the front side may be used as the cassette 20.

Hereinafter, the load port 100, the index module 200, the linkage module 300, the application/development module 400, the buffer module 500, the pre/post-exposure treatment module 600, and the interface module 700 will be described in detail.

The load port 100 includes a mounting table 120 on which the cassette 20, in which the substrates W are received, is placed. The mounting table 120 is provided in plural, and the plurality of mounting tables 120 is disposed in a row in the second direction 14. Four mounting tables 120 are illustrated in FIG. 1.

The index module 200 transfers a substrate W between the cassette 20 placed on the mounting table 120 of the load port 100 and the linkage module 300. The index module 200 includes a frame 210, an index robot 220, and a guide rail 230. The frame 210 has a substantially rectangular parallelepiped shape having an empty interior, and is disposed between the load part 100 and the linkage module 300. The frame 210 of the index module 200 may be formed to have a smaller height than a frame 310 of the linkage module 300, which will be described later. The index robot 220 and the guide rail 230 are disposed in the frame 210. The index robot 220 picks up and places the substrate W. The index robot 220 may be moved along the guide rail 230. In addition, the index robot 220 may be rotated with respect to the guide rail 230. In addition, although not shown, a door opener configured to open and close a door of the cassette 20 is provided in the frame 210.

The linkage module 300 is located on a path through which a substrate to be processed is unloaded from the cassette 20 and is then loaded therein or a processed substrate is unloaded therefrom and is then loaded in the cassette 20, thereby providing a space in which the substrate is temporarily stored. The linkage module 300 includes a frame 310, a first buffer 320, a second buffer 330, a cooling chamber 350, and a first buffer robot 360. The frame 310 has a rectangular parallelepiped shape having an empty interior, and is disposed between the index module 200 and the application/development module 400. The first buffer 320, the second buffer 330, the cooling chamber 350, and the first buffer robot 360 are located in the frame 310. The cooling chamber 350, the second buffer 330, and the first buffer 320 are sequentially disposed from below in the third direction 16. The first buffer 320 is located at a position corresponding to an application module 401 of the application/development module 400, which will be described later, and the second buffer 330 and the cooling chamber 350 are located at a height corresponding to a development module 402 of the application/development module 400, which will be described later. The first buffer robot 360 is disposed so as to be spaced apart from the second buffer 330, the cooling chamber 350, and the first buffer 320 by a predetermined distance in the second direction 14.

The first buffer 320 and the second buffer 330 temporarily store a plurality of substrates W. The second buffer 330 includes a housing 331 and a plurality of supports 332. The supports 332 are disposed in the housing 331, and are spaced apart from each other in the third direction 16. One substrate W is placed on each of the supports 332. In order to allow the index robot 220, the first buffer robot 360, and a development robot 482 of the development module 402, which will be described later, to load or unload the substrate W on or from the support 332 in the housing 331, the housing 331 includes openings (not shown) formed on a side on which the index robot 220 is provided, a side on which the first buffer robot 360 is provided, and a side on which the development robot 482 is provided. The first buffer 320 has a similar structure to the second buffer 330. However, the housing 321 of the first buffer 320 includes openings formed on a side on which the first buffer robot 360 is provided and a side on which an application robot 432 located in the application module 401, which will be described later, is provided. The number of supports 322 included in the first buffer 320 and the number of supports 332 included in the second buffer 330 may be the same or different. According to an embodiment, the number of supports 332 included in the second buffer 330 may be greater than the number of supports 322 included in the first buffer 320.

The first buffer robot 360 transfers the substrate W between the first buffer 320 and the second buffer 330. The first buffer robot 360 includes a hand 361, an arm 362, and a support 363. The hand 361 is fixedly mounted to the arm 362. The arm 362 has a stretchable structure to allow the hand 361 to move in the second direction 14. The arm 362 is coupled to the support 363 so as to be linearly movable in the third direction 16 along the support 363. The support 363 has a length extending from a position corresponding to the second buffer 330 to a position corresponding to the first buffer 320. The support 363 may be formed to extend longer upwards or downwards than the first buffer 320 and the second buffer 330. The first buffer robot 360 may be formed such that the hand 361 is two-axis driven in the second direction 14 and the third direction 16.

The cooling chamber 350 cools the substrate W. The cooling chamber 350 includes a housing 351 and a cooling plate 352. The cooling plate 352 includes an upper surface on which the substrate W is placed and a cooling device 353 configured to cool the substrate W. The cooling device 353 may be implemented in various cooling types, such as a cooling type using coolant or a cooling type using a thermoelectric element. In addition, the cooling chamber 350 may be provided with a lift pin assembly (not shown) configured to place the substrate W on the cooling plate 352. The housing 351 includes openings (not shown) formed on a side on which the index robot 220 is provided and a side on which the development robot 482 of the development module 402, which will be described later, is provided. In addition, the cooling chamber 350 may be provided with doors (not shown) configured to open and close the aforementioned openings.

The application/development module 400 performs a process of applying a photoresist onto the substrate W before an exposure process and performs a process of developing the substrate W after the exposure process. The application/development module 400 has a substantially rectangular parallelepiped shape. The application/development module 400 includes an application module 401 and a development module 402. The application module 401 and the development module 402 are disposed in separate layers so as to be partitioned from each other. According to an embodiment, the application module 401 is located above the development module 402.

The application module 401 performs a process of applying a photosensitive liquid such as a photoresist onto the substrate W and a heat treatment process of heating and cooling the substrate W before and after the resist application process. The application module 401 includes a resist application chamber 410, a bake chamber 420, and a transfer chamber 430. The resist application chamber 410, the bake chamber 420, and the transfer chamber 430 are sequentially disposed in the second direction 14. Accordingly, the resist application chamber 410 and the bake chamber 420 are spaced apart from each other in the second direction 14 with the transfer chamber 430 interposed therebetween. The resist application chamber 410 is provided in plural, and the plurality of resist application chambers 410 is provided in each of the first direction 12 and the third direction 16. Six resist application chambers 410 are illustrated in the drawings by way of example. The bake chamber 420 is provided in plural, and the plurality of bake chambers 420 is provided in each of the first direction 12 and the third direction 16. Six bake chambers 420 are illustrated in the drawings by way of example. However, a greater number of bake chambers 420 than those illustrated in the drawings may be provided.

The transfer chamber 430 is located parallel to the first buffer 320 of the linkage module 300 in the first direction 12. An application robot 432 and a guide rail 433 are located in the transfer chamber 430. The transfer chamber 430 has a substantially rectangular shape. The application robot 432 transfers the substrate W between the bake chambers 420, the resist application chambers 410, the first buffer 320 of the linkage module 300, and a first cooling chamber 530 of the buffer module 500, which will be described later. The guide rail 433 is disposed such that the longitudinal direction thereof is parallel to the first direction 12. The guide rail 433 guides the application robot 432 such that the application robot 432 is linearly moved in the first direction 12. The application robot 432 includes a hand 434, an arm 435, a support 436, and a base 437.

The hand 434 is fixedly mounted to the arm 435. The arm 435 has a stretchable structure to allow the hand 434 to move in the horizontal direction. The support 436 is disposed such that the longitudinal direction thereof is parallel to the third direction 16. The arm 435 is coupled to the support 436 so as to be linearly movable in the third direction 16 along the support 436. The support 436 is fixedly coupled to the base 437, and the base 437 is coupled to the guide rail 433 so as to be movable along the guide rail 433.

All the resist application chambers 410 have the same structure. However, the types of photoresists used in the respective resist application chambers 410 may be different. For example, a chemical amplification resist may be used as the photoresist. The resist application chamber 410 applies a photoresist onto the substrate W. The resist application chamber 410 includes a housing 411, a support plate 412, and a nozzle 413. The housing 411 has a cup shape with an open top. The support plate 412 is located in the housing 411 and supports the substrate W. The support plate 412 is rotatably provided. The nozzle 413 supplies a photoresist onto the substrate W placed on the support plate 412. The nozzle 413 may have a circular tubular shape, and may supply a photoresist to the center of the substrate W. Optionally, the nozzle 413 may have a length corresponding to the diameter of the substrate W, and the discharge port of the nozzle 413 may be formed as a slit. In addition, the resist application chamber 410 may be further provided with a nozzle 414 for supplying a cleaning liquid such as deionized water in order to clean the surface of the substrate W coated with the photoresist.

The bake chamber 420 heat-treats the substrate W. For example, the bake chambers 420 perform a pre-bake process of, before the photoresist is applied, heating the substrate W to a predetermined temperature to remove organic matter or moisture from the surface of the substrate W, perform a soft bake process after the photoresist is applied onto the substrate W, and perform a cooling process of cooling the substrate W after the respective heating processes. The bake chamber 420 includes a cooling plate 421 or a heating plate 422. The cooling plate 421 is provided with a cooling device 423 using coolant or a thermoelectric element. Further, the heating plate 422 is provided with a heating device 424 using a heating wire or a thermoelectric element. The cooling plate 421 and the heating plate 422 may be provided in each of the bake chambers 420. Optionally, some of the bake chambers 420 may be provided with only the cooling plate 421, while the others may be provided with only the heating plate 422.

The development module 402 performs a development process of supplying a developer to remove a part of the photoresist in order to obtain a pattern on the substrate W and a heat treatment process of heating and cooling the substrate W before and after the development process. The development module 402 includes a development chamber 800, a bake chamber 470, and a transfer chamber 480. The development chamber 800, the bake chamber 470, and the transfer chamber 480 are sequentially disposed in the second direction 14. Accordingly, the development chamber 800 and the bake chamber 470 are spaced apart from each other in the second direction 14 with the transfer chamber 480 interposed therebetween. The development chamber 800 is provided in plural, and the plurality of development chambers 800 is provided in each of the first direction 12 and the third direction 16. Six development chambers 800 are illustrated in the drawings by way of example. The bake chamber 470 is provided in plural, and the plurality of bake chambers 470 is provided in each of the first direction 12 and the third direction 16. Six bake chambers 470 are illustrated in the drawings by way of example. However, a greater number of bake chambers 470 than those illustrated in the drawings may be provided.

The transfer chamber 480 is located parallel to the second buffer 330 of the linkage module 300 in the first direction 12. A development robot 482 and a guide rail 483 are located in the transfer chamber 480. The transfer chamber 480 has a substantially rectangular shape. The development robot 482 transfers the substrate W between the bake chambers 470, the development chambers 800, the second buffer 330 of the linkage module 300, the cooling chamber 350 of the linkage module 300, and the second cooling chamber 540 of the buffer module 500. The guide rail 483 is disposed such that the longitudinal direction thereof is parallel to the first direction 12. The guide rail 483 guides the development robot 482 such that the development robot 482 is linearly moved in the first direction 12. The development robot 482 includes a hand 484, an arm 485, a support 486, and a base 487. The hand 484 is fixedly mounted to the arm 485. The arm 485 has a stretchable structure to allow the hand 484 to move in the horizontal direction. The support 486 is disposed such that the longitudinal direction thereof is parallel to the third direction 16. The arm 485 is coupled to the support 486 so as to be linearly movable in the third direction 16 along the support 486. The support 486 is fixedly coupled to the base 487. The base 487 is coupled to the guide rail 483 so as to be movable along the guide rail 483.

The buffer module 500 is provided as a passage through which the substrate W is transferred between the application/development module 400 and the pre/post-exposure treatment module 600. Further, the buffer module 500 performs a predetermined process, such as a cooling process or an edge exposure process, on the substrate W. The buffer module 500 includes a frame 510, a buffer 520, a first cooling chamber 530, a second cooling chamber 540, an edge exposure chamber 550, and a second buffer robot 560. The frame 510 has a rectangular parallelepiped shape. The buffer 520, the first cooling chamber 530, the second cooling chamber 540, the edge exposure chamber 550, and the second buffer robot 560 are located in the frame 510. The buffer 520, the first cooling chamber 530, and the edge exposure chamber 550 are disposed at a height corresponding to the application module 401. The second cooling chamber 540 is disposed at a height corresponding to the development module 402. The buffer 520, the first cooling chamber 530, and the second cooling chamber 540 are sequentially disposed in a row in the third direction 16. When viewed from above, the buffer 520 is disposed in the first direction 12 together with the transfer chamber 430 of the application module 401. The edge exposure chamber 550 is disposed so as to be spaced apart from the buffer 520 or the first cooling chamber 530 by a predetermined distance in the second direction 14.

The second buffer robot 560 transfers the substrate W between the buffer 520, the first cooling chamber 530, and the edge exposure chamber 550. The second buffer robot 560 is located between the edge exposure chamber 550 and the buffer 520. The second buffer robot 560 may be formed in a similar structure to the first buffer robot 360. The first cooling chamber 530 and the edge exposure chamber 550 perform subsequent processes on the substrates W having undergone processing in the application module 401. The first cooling chamber 530 cools the substrate W having undergone processing in the application module 401. The first cooling chamber 530 has a similar structure to the cooling chamber 350 of the first buffer module 300. The edge exposure chamber 550 exposes edges of the substrates W having undergone the cooling process in the first cooling chamber 530. The buffer 520 temporarily stores the substrates W having undergone processing in the edge exposure chamber 550 before the substrates W are transferred to a pre-treatment module 601 to be described later. The second cooling chamber 540 cools the substrates W having undergone processing in a post-treatment module 602 to be described later before the substrates W are transferred to the development module 402. The buffer module 500 may further include an additional buffer located at a height corresponding to the development module 402. In this case, the substrates W having undergone processing in the post-treatment module 602 may be temporarily stored in the added buffer, and may then be transferred to the development module 402.

The pre/post-exposure treatment module 600 may perform a process of applying a protective film to protect the photoresist film applied to the substrate W when an exposure device 900 performs an immersion exposure process. In addition, the pre/post-exposure treatment module 600 may perform a process of cleaning the substrate W after exposure. Further, when the application process is performed using a chemical amplification resist, the pre/post-exposure treatment module 600 may perform a post-exposure bake process.

The pre/post-exposure treatment module 600 includes a pre-treatment module 601 and a post-treatment module 602. The pre-treatment module 601 performs a process of treating the substrate W before the exposure process, and the post-treatment module 602 performs a process of treating the substrate W after the exposure process. The pre-treatment module 601 and the post-treatment module 602 are disposed in separate layers so as to be partitioned from each other. For example, the pre-treatment module 601 is located above the post-treatment module 602. The pre-treatment module 601 is provided at the same height as the application module 401. The post-treatment module 602 is provided at the same height as the development module 402. The pre-treatment module 601 includes a protective film application chamber 610, a bake chamber 620, and a transfer chamber 630. The protective film application chamber 610, the transfer chamber 630, and the bake chamber 620 are sequentially disposed in the second direction 14. Accordingly, the protective film application chamber 610 and the bake chamber 620 are located so as to be spaced apart from each other in the second direction 14 with the transfer chamber 630 interposed therebetween. The protective film application chamber 610 is provided in plural, and the plurality of protective film application chambers 610 is disposed in separate layers in the third direction 16. Optionally, the plurality of protective film application chambers 610 may be provided in each of the first direction 12 and the third direction 16. The bake chamber 620 is provided in plural, and the plurality of bake chambers 620 is disposed in separate layers in the third direction 16. Optionally, the plurality of bake chambers 620 may be provided in each of the first direction 12 and the third direction 16.

The transfer chamber 630 is located parallel to the first cooling chamber 530 of the buffer module 500 in the first direction 12. A pre-treatment robot 632 is located in the transfer chamber 630. The transfer chamber 630 has a substantially square or rectangular shape. The pre-treatment robot 632 transfers the substrate W between the protective film application chambers 610, the bake chambers 620, the buffer 520 of the buffer module 500, and a first buffer 720 of the interface module 700, which will be described later. The pre-treatment robot 632 includes a hand 633, an arm 634, and a support 635. The hand 633 is fixedly mounted to the arm 634. The arm 634 is formed in a stretchable and rotatable structure. The arm 634 is coupled to the support 635 so as to be linearly movable in the third direction 16 along the support 635.

The protective film application chamber 610 applies a protective film onto the substrate W in order to protect the resist film during immersion exposure. The protective film application chamber 610 includes a housing 611, a support plate 612, and a nozzle 613. The housing 611 has a cup shape with an open top. The support plate 612 is located in the housing 611 and supports the substrate W. The support plate 612 is rotatably provided. The nozzle 613 supplies a protective liquid onto the substrate W placed on the support plate 612 in order to form the protective film. The nozzle 613 may have a circular tubular shape, and may supply the protective liquid to the center of the substrate W. Optionally, the nozzle 613 may have a length corresponding to the diameter of the substrate W, and the discharge port of the nozzle 613 may be formed as a slit. In this case, the support plate 612 may be provided in a fixed state. The protective liquid contains a foaming material. A material having a low affinity for the photoresist and water may be used as the protective liquid. For example, the protective liquid may contain a fluorine-based solvent. The protective film application chamber 610 supplies the protective liquid to the central area of the substrate W while rotating the substrate W placed on the support plate 612.

The bake chamber 620 heat-treats the substrate W coated with the protective film. The bake chamber 620 includes a cooling plate 621 or a heating plate 622. The cooling plate 621 is provided with a cooling device 623 using coolant or a thermoelectric element. Further, the heating plate 622 is provided with a heating device 624 using a heating wire or a thermoelectric element. The heating plate 622 and the cooling plate 621 may be provided in each of the bake chambers 620. Optionally, some of the bake chambers 620 may be provided with only the heating plate 622, while the others may be provided with only the cooling plate 621.

The post-treatment module 602 includes a cleaning chamber 660, a post-exposure bake chamber 670, and a transfer chamber 680. The cleaning chamber 660, the transfer chamber 680, and the post-exposure bake chamber 670 are sequentially disposed in the second direction 14. Accordingly, the cleaning chamber 660 and the post-exposure bake chamber 670 are located so as to be spaced apart from each other in the second direction 14 with the transfer chamber 680 interposed therebetween. The cleaning chamber 660 may be provided in plural, and the plurality of cleaning chambers 660 may be disposed in separate layers in the third direction 16. Optionally, the plurality of cleaning chambers 660 may be provided in each of the first direction 12 and the third direction 16. The post-exposure bake chamber 670 may be provided in plural, and the plurality of post-exposure bake chambers 670 may be disposed in separate layers in the third direction 16. Optionally, the plurality of post-exposure bake chambers 670 may be provided in each of the first direction 12 and the third direction 16.

The transfer chamber 680 is located parallel to the second cooling chamber 540 of the buffer module 500 in the first direction 12 when viewed from above. The transfer chamber 680 has a substantially square or rectangular shape. A post-treatment robot 682 is located in the transfer chamber 680. The post-treatment robot 682 transfers the substrate W between the cleaning chambers 660, the post-exposure bake chambers 670, the second cooling chamber 540 of the buffer module 500, and a second buffer 730 of the interface module 700, which will be described later. The post-treatment robot 682 provided in the post-treatment module 602 may be formed in the same structure as the pre-treatment robot 632 provided in the pre-treatment module 601.

The cleaning chamber 660 cleans the substrate W after the exposure process. The cleaning chamber 660 includes a housing 661, a support plate 662, and a nozzle 663. The housing 661 has a cup shape with an open top. The support plate 662 is located in the housing 661 and supports the substrate W. The support plate 662 is rotatably provided. The nozzle 663 supplies a cleaning liquid onto the substrate W placed on the support plate 662. Water such as deionized water may be used as the cleaning liquid. The cleaning chamber 660 supplies the cleaning liquid to the central area of the substrate W while rotating the substrate W placed on the support plate 662. Optionally, while the substrate W rotates, the nozzle 663 may linearly or rotationally move from the central area of the substrate W to the peripheral area of the substrate W.

The post-exposure bake chamber 670 heats the substrate W, which has undergone the exposure process, using far ultraviolet light. The post-exposure bake process is a process of heating the substrate W so as to amplify an acid generated in the photoresist by exposure, thereby completing change in the properties of the photoresist. The post-exposure bake chamber 670 includes a heating plate 672. The heating plate 672 is provided with a heating device 674 using a heating wire or a thermoelectric element. The post-exposure bake chamber 670 may further include therein a cooling plate 671. The cooling plate 671 is provided with a cooling device 673 using coolant or a thermoelectric element. In addition, optionally, a bake chamber including only the cooling plate 671 may be further included.

As described above, in the pre/post-exposure treatment module 600, the pre-treatment module 601 and the post-treatment module 602 are provided so as to be completely separated from each other. Further, the transfer chamber 630 of the pre-treatment module 601 and the transfer chamber 680 of the post-treatment module 602 may be formed in the same size and may thus be provided so as to completely overlap each other when viewed from above. Further, the protective film application chamber 610 and the cleaning chamber 660 may be formed in the same size and may thus be provided so as to completely overlap each other when viewed from above. Furthermore, the bake chamber 620 and the post-exposure bake chamber 670 may be formed in the same size and may thus be provided so as to completely overlap each other when viewed from above.

The interface module 700 transfers the substrate W between the pre/post-exposure treatment module 600 and the exposure device 900. The interface module 700 includes a frame 710, a first buffer 720, a second buffer 730, and an interface robot 740. The first buffer 720, the second buffer 730, and the interface robot 740 are located in the frame 710. The first buffer 720 and the second buffer 730 are disposed in a stacked manner while being spaced a predetermined distance from each other. The first buffer 720 is disposed at a higher position than the second buffer 730. The first buffer 720 is disposed at a height corresponding to the pre-treatment module 601, and the second buffer 730 is disposed at a height corresponding to the post-treatment module 602. When viewed from above, the first buffer 720 is disposed in alignment with the transfer chamber 630 of the pre-treatment module 601 in the first direction 12, and the second buffer 730 is disposed in alignment with the transfer chamber 630 of the post-treatment module 602 in the first direction 12.

The interface robot 740 is located so as to be spaced apart from the first buffer 720 and the second buffer 730 in the second direction 14. The interface robot 740 transfers substrate W between the first buffer 720, the second buffer 730, and the exposure device 900. The interface robot 740 has a similar structure to the second buffer robot 560.

The first buffer 720 temporarily stores the substrates W having undergone processing in the pre-treatment module 601 before the substrates W are transferred to the exposure device 900. In addition, the second buffer 730 temporarily stores the substrates W having undergone processing in the exposure device 900 before the substrates W are transferred to the post-treatment module 602. The first buffer 720 includes a housing 721 and a plurality of supports 722. The supports 722 are disposed in the housing 721, and are spaced apart from each other in the third direction 16. One substrate W is placed on each of the supports 722. In order to allow the interface robot 740 and the pre-treatment robot 632 to load or unload the substrate W in or from the support 722 in the housing 721, the housing 721 includes openings (not shown) formed on a side on which the interface robot 740 is provided and a side on which the pre-treatment robot 632 is provided. The second buffer 730 has a similar structure to the first buffer 720. However, the housing 731 of the second buffer 730 includes openings (not shown) formed on a side on which the interface robot 740 is provided and a side on which the post-treatment robot 682 is provided. The interface module may be provided with only the buffers and the robot, as described above, without a chamber in which a predetermined process is performed on the substrate W.

All the development chambers 800 have the same structure. However, the types of developers used in the respective development chambers 800 may be different. The development chamber 800 is provided as a device that develops the substrate. The development chamber 800 removes the light-exposed region of the photoresist on the substrate W. At this time, the light-exposed region of the protective film is also removed. Depending on the type of photoresist used, only the unexposed regions of the photoresist and the protective film may be selectively removed.

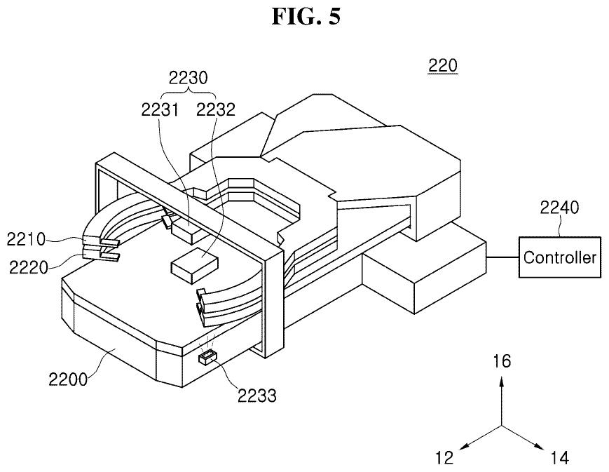

FIG. 5 is a view showing the index robot 220. Referring to FIG. 5, the index robot 220 includes a robot arm 2200, an upper robot hand 2210, a lower robot hand 2220, an upper camera 2231, a lower camera 2232, and a controller 2240. The upper camera 2231 and the lower camera 2232 may collectively be referred to as a camera module 2230. The substrate transfer robot (the index robot 220) of the present disclosure includes a robot arm 2200, an upper robot hand 2210 coupled to the robot arm 2200 to support a first substrate S1 from below, a lower robot hand 2220 coupled to the robot arm 2200 at a position below the upper robot hand 2210 to support a second substrate S2 from below, an upper camera 2231 disposed above the upper robot hand 2210, and a lower camera 2232 disposed below the lower robot hand 2220. The upper camera 2231 and the lower camera 2232 capture images of the first substrate S1 and the second substrate S2 in directions tilted from the inner sides of the substrates toward the outer sides of the substrates.

The robot arm 2200 supports the upper robot hand 2210 and the lower robot hand 2220. For example, the robot arm 2200 is formed in a block shape, and the upper robot hand 2210 and the lower robot hand 2220 are coupled to the robot arm 2200 so as to be movable in the forward-backward direction. The upper robot hand 2210 and the lower robot hand 2220 are formed in a shape in which the inner sides thereof are open in the upward-downward direction, and may support the lower surfaces of the outer sides of the first substrate S1 and the second substrate S2.

The upper camera 2231 and the lower camera 2232 detect the positions of the first substrate S1 and the second substrate S2 placed on the upper robot hand 2210 and the lower robot hand 2220, respectively. Each of the upper camera 2231 and the lower camera 2232 may be provided in plural. For example, as shown in FIG. 5, the upper camera 2231 may be located above the first substrate S1. Similarly, the lower camera 2232 may be located below the second substrate S2. Each of the upper camera 2231 and the lower camera 2232 may be provided individually. The upper camera 2231 and the lower camera 2232 may be located at positions corresponding to the edges of the inner sides of the first substrate S1 and the second substrate S2. The upper camera 2231 and the lower camera 2232 are mounted to be tilted from the inner sides of the first substrate S1 and the second substrate S2 toward the outer sides thereof.

The upper camera 2231 and the lower camera 2232 may be coupled to the upper robot hand 2210 and the lower robot hand 2220 via brackets (not shown), respectively. The upper camera 2231 and the lower camera 2232 may be coupled to the upper robot hand 2210 and the lower robot hand 2220 via rotatable brackets, respectively, whereby the image-capturing angles of the upper camera 2231 and the lower camera 2232 may be adjusted.

The substrate transfer robot (the index robot 220) may further include a lighting device 2233, which is disposed below the lower robot hand 2220 and is configured to radiate light. The light device 2233 may be coupled to each of both side surfaces of the robot arm 2200. The lighting device 2233 may radiate light toward the upper robot hand 2210 and the lower robot hand 2220 located above the light device 2233.

The controller 2240 may acquire position information of the substrates S1 and S2 using image signals from the upper camera 2231 and the lower camera 2232. The controller 2240 may detect the positions of the first substrate S1 and the second substrate S2 through computational processing of the image data captured by the upper camera 2231 and the lower camera 2232. As the index robot 220 transfers the substrates S1 and S2, the controller 2240 may control the index robot 220 using the calculated position information of the substrates S1 and S2, ensuring the substrates S1 and S2 are positioned correctly. The controller 2240 may calculate the center positions of the substrates S1 and S2 from the image data captured by the upper camera 2231 and the lower camera 2232. When the substrates S1 and S2 are transferred to specific positions, the controller 2240 may control the index robot 220 so that the calculated centers of the substrates S1 and S2 are located at the designated positions.

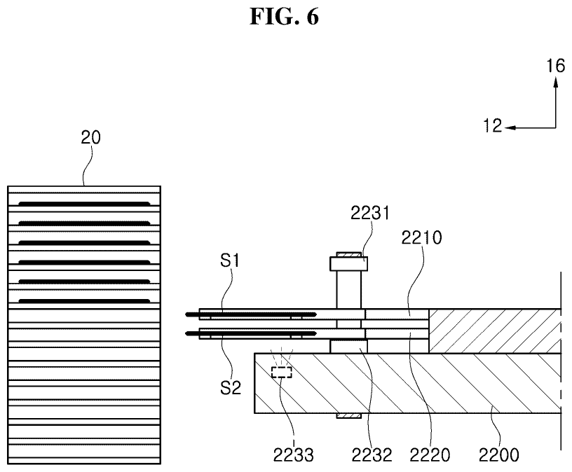

FIG. 6 is a view showing a state in which the index robot 220 unloads the substrates S1 and S2 from the cassette 20. Referring to FIG. 6, the index robot 220 may unload two substrates S1 and S2 from the cassette 20 and may transfer the two substrates S1 and S2 to the linkage module 300.

As one example, if two substrates are located adjacently, such as being contiguously stacked in the vertical direction in the cassette 20, the upper robot hand 2210 and the lower robot hand 2220 may unload the two substrates S1 and S2 at the same time. As another example, if the two substrates S1 and S2 are spaced apart, such as being non-contiguously located in the cassette 20 or being located in separate cassettes 20, the upper robot hand 2210 may unload the first substrate S1, followed by the lower robot hand 2220 unloading the second substrate S2.

As one example, when the substrates S1 and S2 are loaded in the linkage module 300, if the loading positions of the substrates S1 and S2 are adjacent to each other, such as being contiguous with each other in the vertical direction, the upper robot hand 2210 and the lower robot hand 2220 may load the two substrates S1 and S2 at the same time. As another example, if the loading positions of the substrates S1 and S2 are spaced apart, such as being not contiguous with each other, one of the upper robot hand 2210 and the lower robot hand 2220 may load one of the substrates, followed by the other of the upper robot hand 2210 and the lower robot hand 2220 loading the other of the substrates.

In addition, the index robot 220 may unload the two substrates S1 and S2 from the linkage module 300 in a similar manner to that described above, and may transfer the two substrates to the cassette 20.

Further, if only one substrate is to be transferred, the upper robot hand 2210 or the lower robot hand 2220 may transfer the substrate between the cassette 20 and the linkage module 300.

Before the index robot 220 loads the substrates S1 and S2 in the cassette 20 or the linkage module 300, the controller 2240 may calculate the position of the first substrate S1 seated on the upper robot hand 2210 or the position of the second substrate S2 seated on the lower robot hand 2220. When the position of the first substrate S1 or the second substrate S2 is calculated, the controller 2240 may control the driving amount of the robot arm 2200, the upper robot hand 2210, or the lower robot hand 2220 based on the position information of the first substrate S1 or the second substrate S2. The controller 2240 may calculate a distance and an angle by which the measured position of the first substrate S1 or the second substrate S2 is offset from the designated position, and may correct the driving amount of the robot arm 2200, the upper robot hand 2210, or the lower robot hand 2220 based on the calculated offset distance and angle.

If the position of the first substrate S1 or the second substrate S2 is offset from the reference position by a certain amount or more, the controller 2240 may control the robot arm 2200, the upper robot hand 2210, or the lower robot hand 2220 so that the upper robot hand 2210 or the lower robot hand 2220 places the first substrate S1 or the second substrate S2 back to the original position thereof and then picks the same up again.

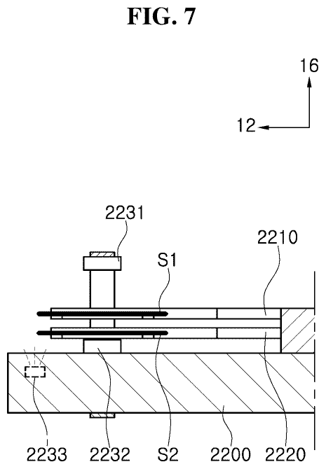

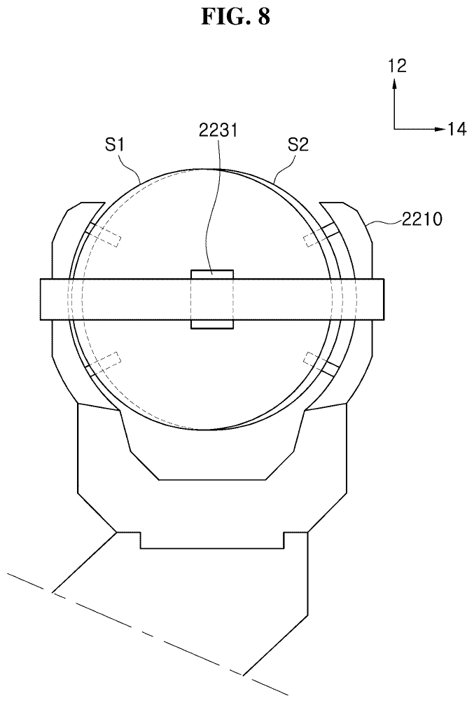

FIG. 7 is a side view showing a state in which the upper robot hand 2210 and the lower robot hand 2220 support the substrates S1 and S2, and FIG. 8 is a plan view showing a state in which the upper robot hand 2210 and the lower robot hand 2220 support the substrates S1 and S2.

Referring to FIGS. 7 and 8, the upper camera 2231 and the lower camera 2232 may be provided separately from each other, and may capture images of the first and second substrates S1 and S2 while being tilted from the inner sides of the substrates toward the outer sides of the substrates. The controller 2240 may recognize the shapes of the edges of the substrates S1 and S2 using the images captured by the upper camera 2231 and the lower camera 2232, thereby calculating the position information of the substrates S1 and S2. In this case, the number of upper cameras 2231 and the number of lower cameras 2232 are not limited. For example, a single upper camera 2231 and a single lower camera 2232 may be provided.

As a general method of detecting position misalignment of the substrate S1 or S2, an optical sensor, which is composed of a light-emitting unit and a light-receiving unit, is disposed near the edge of the substrate S1 or S2. In this case, the light-emitting unit radiates light in the vertical direction (the third direction 16), and the light-receiving unit receives the light radiated in the vertical direction. Based on whether the light is received, position misalignment of the substrate S1 or S2 may be detected. If the position of the substrate S1 or S2 is offset from the designated position, light produced by some of a plurality of optical sensors is blocked and thus is not received by the light-receiving units of the corresponding optical sensors. In this way, position misalignment of the substrate S1 or S2 is detected.

However, application of the method of detecting position misalignment of the substrate S1 or S2 through radiation of light in the vertical direction to the substrate transfer robot that transfers the plurality of substrates S1 and S2 causes several problems. For example, if one of the plurality of substrates S1 and S2 is misaligned, it is difficult to determine which substrate is misaligned or the degree of misalignment.

The present disclosure proposes a method for solving this problem. According to the present disclosure, since the upper camera 2231 and the lower camera 2232 capture images of the first and second substrates S1 and S2 while being tilted from the inner sides of the substrates toward the outer sides of the substrates, the position of the first substrate S1 held by the upper robot hand 2210 and the position of the second substrate S2 held by the lower robot hand 2220 may be accurately determined. If the upper camera 2231 and the lower camera 2232 capture images of the first substrate S1 and the second substrate S2 in the vertical direction (the third direction 16), it is difficult to determine which of the two substrates S1 and S2 is misaligned. As described in the present disclosure, since the upper camera 2231 and the lower camera 2232 capture images of the first and second substrates S1 and S2 while being tilted from the inner sides of the substrates toward the outer sides of the substrates, the first substrate S1 and the second substrate S2 do not interfere with each other in the respective images, with a result that the positions of the substrates are accurately recognized.

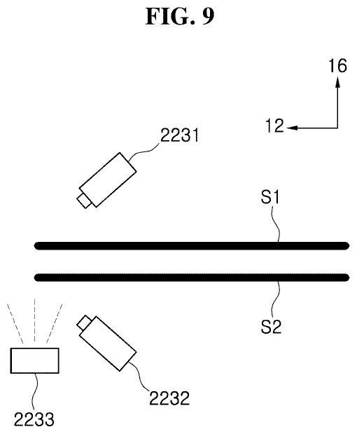

FIG. 9 is a view schematically showing the structure for recognizing the positions of the substrates. FIG. 9 shows the first and second substrates S1 and S2 supported by the substrate transfer robot, the upper and lower cameras 2231 and 2232 configured to recognize the positions of the first and second substrates S1 and S2, and the lighting device 2233.

Referring to FIG. 9, the first substrate S1 and the second substrate S2 are disposed so as to be stacked one above the other in the third direction 16, and the upper camera 2231 and the lower camera 2232 are located farther inward than the edges of the first and second substrates S1 and S2 and capture images of the first and second substrates S1 and S2 while being tilted toward the edges of the first and second substrates S1 and S2, respectively.

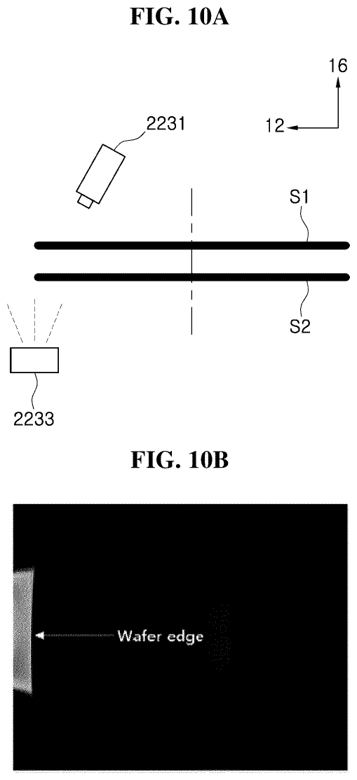

FIGS. 10A and 10B illustrate a process of recognizing the position of the first substrate S1 using the upper camera 2231. As depicted in FIG. 10A, the upper camera 2231 captures an image of the edge of the first substrate S1 (hereinafter referred to as a first image) from above the upper robot hand 2210 while being tilted toward the edge of the first substrate S1. The edge of the first substrate S1 may be identified in the first image, such as that shown in FIG. 10B.

The position of the first substrate S1 on the upper robot hand 2210 is recognized using the first image captured by the upper camera 2231. The controller 2240 may acquire the first image captured by the upper camera 2231, and may analyze the first image to recognize the position of the first substrate S1 on the upper robot hand 2210. For example, the controller 2240 may compare the shape of the edge of the first substrate S1 in the first image with the shape of the edge of the substrate in the pre-stored image to recognize the position of the first substrate S1 on the upper robot hand 2210. The controller 2240 may compare the shape of the edge of the substrate at the normal position with the shape of the edge of the first substrate S1 in the first image captured by the upper camera 2231 to calculate the position of the center point of the first substrate S1.

When it is determined based on the first image captured by the upper camera 2231 that the position of the first substrate S1 is offset from the designated position, the upper robot hand 2210 or the robot arm 2200 may be moved by a distance corrected based on the offset of the first substrate S1. The controller 2240 may compare the position of the center point of the first substrate S1 with the position of the reference center point, and may compensate for the error of the calculated position of the center point of the first substrate S1 with respect to the position of the reference center point, thereby correcting the movement amount of the upper robot hand 2210 or the robot arm 2200. Alternatively, when the position of the first substrate S1 is offset from the reference position by a threshold value or more, the controller 2240 may control the substrate transfer robot (the index robot 220) to again pick up the first substrate S1, or may output an alarm.

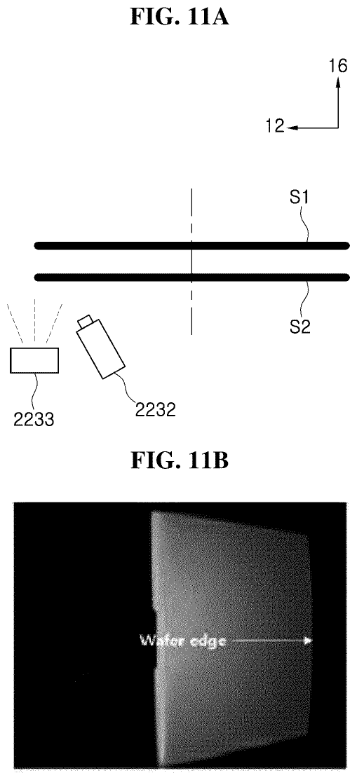

FIGS. 11A and 11B illustrate a process of recognizing the position of the second substrate S2 using the lower camera 2232. As depicted in FIG. 11A, the lower camera 2232 captures an image of the edge of the second substrate S2 (hereinafter referred to as a second image) from below the lower robot hand 2220 while being tilted toward the edge of the second substrate S2. The edge of the second substrate S2 may be identified in the second image, such as that shown in FIG. 10B.

The position of the second substrate S2 on the lower robot hand 2220 is recognized using the second image captured by the lower camera 2232. The controller 2240 may acquire the second image captured by the lower camera 2232, and may analyze the second image to recognize the position of the second substrate S2 on the lower robot hand 2220. For example, the controller 2240 may compare the shape of the edge of the second substrate S2 in the second image with the shape of the edge of the substrate in the pre-stored image to recognize the position of the second substrate S2 on the lower robot hand 2220. The controller 2240 may compare the shape of the edge of the substrate at the normal position with the shape of the edge of the second substrate S2 in the second image captured by the lower camera 2232 to calculate the position of the center point of the second substrate S2.

When it is determined based on the second image captured by the lower camera 2232 that the position of the second substrate S2 is offset from the designated position, the lower robot hand 2220 or the robot arm 2200 may be moved by a distance corrected based on the offset of the second substrate S2. The controller 2240 may compare the position of the center point of the second substrate S2 with the position of the reference center point, and may compensate for the error of the calculated position of the center point of the second substrate S2 with respect to the position of the reference center point, thereby correcting the movement amount of the lower robot hand 2220 or the robot arm 2200. Alternatively, when the position of the second substrate S2 is offset from the reference position by a threshold value or more, the controller 2240 may control the substrate transfer robot (the index robot 220) to again pick up the second substrate S2, or may output an alarm.

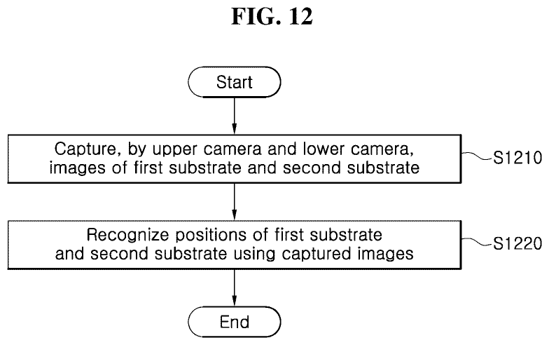

FIG. 12 is a flowchart showing a method of recognizing the positions of the substrates by the substrate transfer robot (the index robot 220). The method of recognizing the positions of the substrates may be performed by the controller 2240. The method of recognizing the positions of the substrates according to the present disclosure includes a step of capturing, by the upper camera 2231 and the lower camera 2232, images of the first substrate S1 and the second substrate S2 (S1210) and a step of recognizing the positions of the first substrate S1 and the second substrate S2 using the captured images (S1220).

In step S1210, the upper camera 2231 and the lower camera 2232 capture images of the first and second substrates S1 and S2 while being tilted from the inner sides of the substrates toward the outer sides of the substrates. Since the upper camera 2231 and the lower camera 2232 capture images of the edges of the first substrate S1 and the second substrate S2 while being tilted from the inner sides of the substrates S1 and S2 toward the outer sides of the substrates S1 and S2, respectively, the shapes of the edges of the first substrate S1 and the second substrate S2 may be acquired using the images in which the first substrate S1 and the second substrate S2 do not interfere with each other.

In step S1220, the controller 2240 may recognize the positions of the first substrate S1 and the second substrate S2 using the images captured by the upper camera 2231 and the lower camera 2232. The controller 2240 may recognize the position of the first substrate S1 on the upper robot hand 2210 using the first image captured by the upper camera 2231, and may recognize the position of the second substrate S2 on the lower robot hand 2220 using the second image captured by the lower camera 2232. The controller 2240 may extract the shapes of the edges of the substrates S1 and S2 from the captured images, and may recognize the positions of the substrates S1 and S2 based on the shapes of the edges thereof. Upon recognizing the positions of the substrates S1 and S2, the controller 2240 may control the substrate transfer robot (the index robot 220) in accordance with the movement amount corrected based on the position information of the substrates S1 and S2.

As is apparent from the above description, according to the present disclosure, since the upper camera and the lower camera capture images of the substrates in directions tilted from the inner sides of the substrates toward the outer sides of the substrates, it may be possible to accurately recognize the positions of the respective substrates.

Although the preferred embodiments of the present disclosure have been disclosed for illustrative purposes, those skilled in the art will appreciate that various modifications, additions and substitutions are possible, without departing from the scope and spirit of the disclosure.

The scope of the present disclosure should be defined only by the accompanying claims, and all technical ideas within the scope of equivalents to the claims should be construed as falling within the scope of the disclosure.

What is claimed is:

1. A substrate transfer robot configured to transfer a substrate in a substrate processing apparatus, the substrate transfer robot comprising:
a robot arm;
an upper robot hand coupled to the robot arm, the upper robot hand being configured to support a first substrate from below;
a lower robot hand coupled to the robot arm at a position below the upper robot hand, the lower robot hand being configured to support a second substrate from below;
an upper camera disposed above the upper robot hand; and
a lower camera disposed below the lower robot hand,
wherein the upper camera and the lower camera capture images of the first substrate and the second substrate in directions tilted from inner sides of the first and second substrates toward outer sides of the first and second substrates.

2. The substrate transfer robot as claimed in claim 1, further comprising a lighting device disposed below the lower robot hand, the lighting device being configured to radiate light.

3. The substrate transfer robot as claimed in claim 1, wherein the upper camera captures a first image of an edge of the first substrate from above the upper robot hand.

4. The substrate transfer robot as claimed in claim 3, wherein a position of the first substrate on the upper robot hand is recognized using the first image.

5. The substrate transfer robot as claimed in claim 4, wherein, when it is determined based on the first image captured by the upper camera that the position of the first substrate is offset from a designated position, the upper robot hand or the robot arm is moved by a distance corrected based on offset of the first substrate.

6. The substrate transfer robot as claimed in claim 1, wherein the lower camera captures a second image of an edge of the second substrate from below the lower robot hand.

7. The substrate transfer robot as claimed in claim 6, wherein a position of the second substrate on the lower robot hand is recognized using the second image.

8. The substrate transfer robot as claimed in claim 7, wherein, when it is determined based on the second image captured by the lower camera that the position of the second substrate is offset from a designated position, the lower robot hand or the robot arm is moved by a distance corrected based on offset of the second substrate.

9. A method of recognizing a position of a substrate by a substrate transfer robot configured to transfer the substrate in a substrate processing apparatus, wherein the substrate transfer robot comprises:
a robot arm;
an upper robot hand coupled to the robot arm, the upper robot hand being configured to support a first substrate from below;
a lower robot hand coupled to the robot arm at a position below the upper robot hand, the lower robot hand being configured to support a second substrate from below;
an upper camera disposed above the upper robot hand; and
a lower camera disposed below the lower robot hand,
wherein the upper camera and the lower camera capture images of the first substrate and the second substrate in directions tilted from inner sides of the first and second substrates toward outer sides of the first and second substrates, and
wherein the method comprises:
capturing, by the upper camera and the lower camera, images of the first substrate and the second substrate; and
recognizing positions of the first substrate and the second substrate using the captured images.

10. The method as claimed in claim 9, wherein the substrate transfer robot further comprises a lighting device disposed below the lower robot hand to radiate light.

11. The method as claimed in claim 9, wherein the upper camera captures a first image of an edge of the first substrate from above the upper robot hand.

12. The method as claimed in claim 11, wherein a position of the first substrate on the upper robot hand is recognized using the first image.

13. The method as claimed in claim 12, wherein, when it is determined based on the first image captured by the upper camera that the position of the first substrate is offset from a designated position, the upper robot hand or the robot arm is moved by a distance corrected based on offset of the first substrate.

14. The method as claimed in claim 9, wherein the lower camera captures a second image of an edge of the second substrate from below the lower robot hand.

15. The method as claimed in claim 14, wherein a position of the second substrate on the lower robot hand is recognized using the second image.

16. The method as claimed in claim 15, wherein, when it is determined based on the second image captured by the lower camera that the position of the second substrate is offset from a designated position, the lower robot hand or the robot arm is moved by a distance corrected based on offset of the second substrate.

17. A substrate processing apparatus comprising:
a load port comprising a mounting table configured to allow a cassette receiving a substrate to be placed thereon;
a linkage module providing a space to store the substrate; and
an index module comprising an index robot configured to transfer the substrate between the load port and the linkage module,
wherein the index robot comprises:
a robot arm;
an upper robot hand coupled to the robot arm, the upper robot hand being configured to support a first substrate from below;
a lower robot hand coupled to the robot arm at a position below the upper robot hand, the lower robot hand being configured to support a second substrate from below;
an upper camera disposed above the upper robot hand; and
a lower camera disposed below the lower robot hand,
wherein the upper camera and the lower camera capture images of the first substrate and the second substrate in directions tilted from inner sides of the first and second substrates toward outer sides of the first and second substrates,
wherein the upper camera captures a first image of an edge of the first substrate from above the upper robot hand,
wherein the lower camera captures a second image of an edge of the second substrate from below the lower robot hand, and
wherein a position of the first substrate on the upper robot hand and a position of the second substrate on the lower robot hand are recognized using the first image and the second image.

18. The substrate processing apparatus as claimed in claim 17, wherein the index robot further comprises a lighting device disposed below the lower robot hand to radiate light.

19. The substrate processing apparatus as claimed in claim 17, wherein, when it is determined based on the first image captured by the upper camera that the position of the first substrate is offset from a designated position, the upper robot hand or the robot arm is moved by a distance corrected based on offset of the first substrate.

20. The substrate processing apparatus as claimed in claim 17, wherein, when it is determined based on the second image captured by the lower camera that the position of the second substrate is offset from a designated position, the lower robot hand or the robot arm is moved by a distance corrected based on offset of the second substrate.
